(19) United States
(12) Patent Application Publication
(10) Pub. No.: US 2025/0163712 A1
(43) Pub. Date: May 22, 2025

(54) SYSTEMS AND METHODS FOR CONTROLLING AN ALKALINITY LEVEL OF A POOL OR SPA

(71) Applicant: Pentair, Inc., Minneapolis, MN (US)

(72) Inventors: Keena Holley, Knightdale, NC (US); Travis Baldwin, Raleigh, NC (US); Dana Stephanie Royer Adams, Holly Springs, NC (US); Caleb Ray, Apex, NC (US); Montie Wayne Roland, Sanford, NC (US); Thomas Johnson Safon, Holly Springs, NC (US); Sean McEwan, Chapel Hill, NC (US)

(21) Appl. No.: 18/954,068

(22) Filed: Nov. 20, 2024

Related U.S. Application Data
(60) Provisional application No. 63/600,942, filed on Nov. 20, 2023.

(51) Int. Cl. E04H 4/12; C02F 1/42; C02F 103/42

(52) U.S. Cl. CPC E04H 4/1281; C02F 1/42; C02F 2001/427; C02F 2103/42; C02F 2209/07; C02F 2209/10

(57) ABSTRACT

A system and method for controlling an alkalinity level of a pool or spa is provided. The method includes the steps of providing a vessel designed to retain an alkalinity agent, measuring an alkalinity value of water of the pool or spa at a first time period, and determining whether the alkalinity value of the water is outside an alkalinity threshold range. The method also includes the steps of determining a first amount of the alkalinity agent to provide to the water of the pool or spa and providing the first amount of the alkalinity agent to the water of the pool or spa. The vessel retaining the alkalinity agent is in fluid communication with the pool or spa.

### CROSS-REFERENCE TO RELATED APPLICATIONS

This Application claims priority to U.S. Provisional Patent Application Ser. No. 63/600,942, filed on Nov. 20, 2023, entitled “A SYSTEM AND A METHOD FOR CONTROLLING ALKALINITY OF A SWIMMING POOL/SPA,” currently pending, the entire disclosure of which is incorporated herein by reference.

### TECHNICAL FIELD

The present disclosure relates to controlling a water chemistry parameter of a swimming pool or spa. More particularly, the present disclosure relates to systems and methods for controlling the alkalinity level of a swimming pool or spa.

### BACKGROUND

Many aquatic applications utilize monitoring of levels of certain chemicals within the water. Alternatively, chemical characteristics of the water associated with certain chemicals may be monitored (e.g., pH value, alkalinity, etc.). In some instances, water treatment chemicals may be automatically added to the water with an automated chemical delivery system in response to detected chemical levels or water chemical characteristics determined as part of the monitoring process.

For example, in a pool or spa setting, the pH value of the water in the system can be determined, and a pH increaser and/or an acid can be added to adjust the pH value. Further, in some instances, the alkalinity value of the water can be monitored because the alkalinity is an indicator of the pH stability. In other words, alkalinity measures how much acid a body of water can neutralize before the pH value changes. Thus, it can be beneficial to maintain the alkalinity within a desired range so that the water can resist pH value fluctuations due to changes in the acid concentration in the water.

Alkalinity is a quality of water that is made up of any compound that can neutralize acids, such as bases, including bicarbonate, borate, cyanuric acid, hydroxides, and the like. In conventional pool systems, it can be desirable to have a large amount of a weak base so that the pool water has a strong pH buffering capacity without resulting in a high pH value that can irritate bathers. Typically, the alkalinity in a pool system is made up of bicarbonate, which is established through the addition of sodium bicarbonate. Thus, some conventional pool systems can include alkalinity generation systems for adding sodium bicarbonate to the pool water.

However, in a swimming pool or spa with an automatic acid control system or acid dosing system, the constant or periodic addition of acid into the water of the swimming pool or spa may result in low alkalinity, which affects the water quality of the swimming pool or spa.

Traditionally, users manually add sodium bicarbonate powder into the swimming pool or spa (e.g., by mixing sodium bicarbonate powder into the water of the swimming pool or spa). Additionally, in existing processes, the user manually calculates an amount of sodium bicarbonate powder to add to the water of the swimming pool or spa. The calculation is not easy to carry out, as the calculation depends not only on the alkalinity value of the swimming pool or spa, but also on a volume of water in the swimming pool or spa.

Therefore, there is a recognized need for a system and a method that automatically controls the alkalinity level of the swimming pool or spa, and preferably with minimal or no manual intervention by the user.

### SUMMARY

In some aspects, a method for controlling an alkalinity level of a pool or spa is provided. The method includes the steps of providing a vessel designed to retain an alkalinity agent, measuring an alkalinity value of water of the pool or spa at a first time period, determining whether the alkalinity value of the water is outside an alkalinity threshold range, determining a first amount of the alkalinity agent to provide to the water of the pool or spa, and providing the first amount of the alkalinity agent to the water of the pool or spa. The vessel is in fluid communication with the pool or spa.

In some instances, the method also includes the steps of transmitting a signal from a controller to a valve, wherein the signal directs the valve to operate in an open state. The water of the pool or spa is provided to the vessel, thereby forming an alkalinity agent-water mixture. A total dissolved solids (TDS) value of the alkalinity agent-water mixture is measured exiting the vessel. The method further includes the step of determining whether a concentration of the alkalinity agent in the alkalinity agent-water mixture corresponds to the first amount.

In other instances, the method also includes the steps of actuating a valve to an open configuration when the alkalinity value of the water is outside of the alkalinity threshold range, and operating the valve in the open configuration for a first predetermined time period.

In yet other instances, the method also includes the step of closing the valve when a concentration of an alkalinity agent-water mixture leaving the vessel corresponds to the first amount.

In some instances, the method also includes the step of operating the valve in a closed configuration after a first predetermined amount of time elapses.

In other instances, the method also includes the step of operating a valve in a closed state after receiving a current TDS value from a TDS sensor that is within a predetermined range of TDS values.

In yet other instances, the method also includes the steps of providing a valve in fluid communication with both the vessel and the pool or spa and providing a controller in electronic communication with the valve. The controller is designed to receive the determined alkalinity value and direct the valve to operate in an open state for a predetermined period of time when a total amount of the alkalinity agent exiting the vessel is below the alkalinity threshold range.

In some instances, the method also includes the steps of the controller receiving a value of an amount of acid dosed into the pool or spa from an acid dosing system and actuating a valve to allow the water of the pool or spa to be combined with a second amount of the alkalinity agent, the second amount associated with the amount of acid provided by the acid dosing system.

In other instances, the method also includes the step of determining a total amount of alkalinity agent dosed to the water exiting the vessel based on (1) an average flow of the water through a flow meter in fluid communication with the vessel, and (2) a TDS value of the water of the pool or spa after the first amount of the alkalinity agent is provided to the pool or spa.

In other aspects, a method for controlling an alkalinity level of a pool or spa includes the steps of providing an alkalinity reagent tank in fluid communication with the pool or spa, determining a water chemistry parameter of the water of the pool or spa at a first time period, and providing a controller in communication with the alkalinity reagent tank. The controller determine s if the alkalinity value is above or below an alkalinity threshold range and determine a first amount of an alkalinity agent to provide to the water of the pool or spa. The water chemistry parameter is associated with an alkalinity value of the water.

In some instances, the method includes the steps of operating a valve in an open state in which the water of the pool or spa flows to the alkalinity reagent tank when the valve is in the open state, receiving an indication from the alkalinity reagent tank after the first amount of the alkalinity agent is released by the alkalinity reagent tank, and operating the valve in a closed state in response to the indication received from the alkalinity reagent tank.

In other instances, the method also includes the step of releasing the first amount of the alkalinity agent.

In yet other instances, the method also includes the step of selectively opening and closing a receptacle of the alkalinity reagent tank to provide the alkalinity agent to the water of the pool or spa.

In some instances, the method also includes the step of closing the receptacle of the alkalinity reagent tank when a sensor associated with the alkalinity reagent tank determines that the first amount of the alkalinity agent has been released from the receptacle.

In yet other aspects, a system for controlling an alkalinity level of a pool or spa is provided in the form of a vessel, a valve, a sensor, and a controller. The vessel is designed to retain an alkalinity agent, and the valve is in fluid communication with the vessel. The valve can be positioned in an open configuration and a closed configuration. The sensor is designed to determine an alkalinity value of the water of the pool or spa. The controller is in electronic communication with the vessel and the sensor, wherein the controller is designed to receive the alkalinity value from the sensor at a first time period, determine a first amount of sodium bicarbonate powder to be mixed with the water of the pool or spa, and direct actuation of the valve into the open configuration and the closed configuration.

In some instances, the system also includes a strainer configured to store the alkalinity agent.

In other instances, an alkalinity agent-water solution is provided from the vessel when the valve is in the open configuration.

In yet other instances, the system also includes a receptacle positioned within the vessel, wherein the alkalinity agent is stored in the receptacle and released by opening and closing an aperture of the receptacle.

In some instances, the controller is also designed to receive a TDS value from a TDS sensor positioned downstream of the vessel and determine whether a concentration of the alkalinity agent in an alkalinity agent-water solution flowing from the vessel is substantially equal to a determined concentration of the alkalinity agent.

In other instances, the controller is also designed to receive an indication from the vessel after the determined first amount of alkalinity agent has been provided from the vessel, and direct actuation of the valve to the closed configuration in response to the indication.

### BRIEF DESCRIPTION OF THE DRAWINGS

FIG. 1 is a schematic diagram of an aquatic application including an alkalinity dosing system designed to control the alkalinity of a swimming pool or spa;

FIG. 2A is an isometric view of an alkalinity reagent tank provided as a component of the alkalinity dosing system of FIG. 1;

FIG. 2B is a cross-sectional view of the alkalinity reagent tank of FIG. 2A taken across the line 2B-2B of FIG. 2A;

FIG. 2C is a cross-sectional view of another instance of the alkalinity reagent tank of FIG. 2A;

FIG. 3 is a block diagram of a controller associated with the alkalinity reagent tank of FIG. 2A;

FIG. 4 illustrates a flow diagram depicting a method for controlling an alkalinity level of a swimming pool or spa; and

FIG. 5 illustrates a flow diagram depicting another method for controlling an alkalinity level of a swimming pool or spa;

FIG. 6 illustrates a flow diagram depicting yet another method for controlling an alkalinity level of a swimming pool or spa; and

FIG. 7 illustrates a flow diagram depicting another method for controlling an alkalinity level of a swimming pool or spa.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

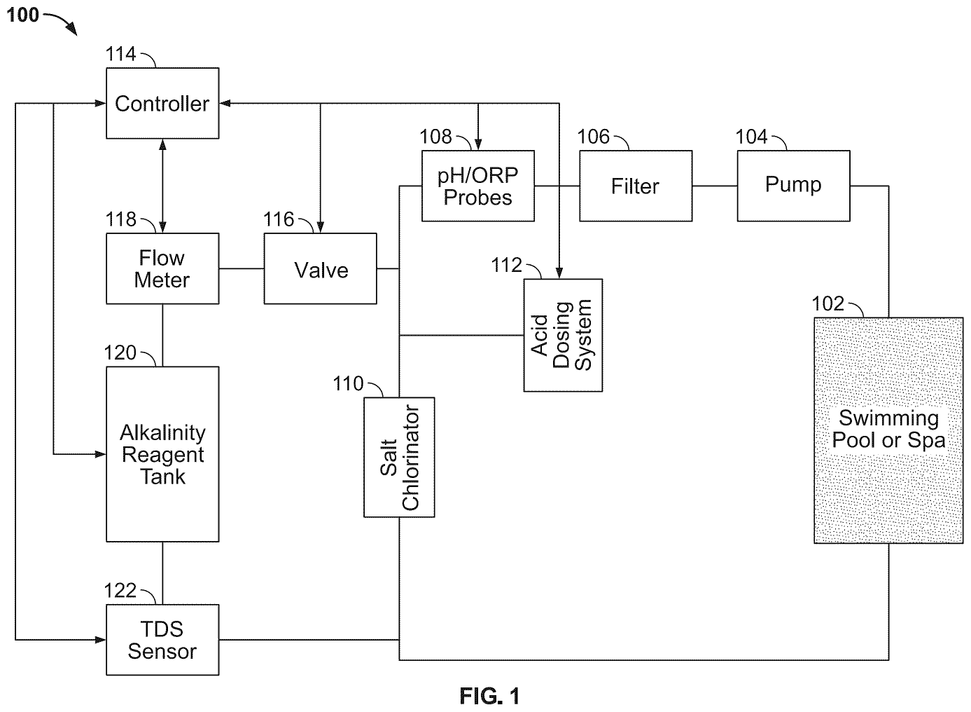

Referring to FIG. 1, an aquatic application 100 including a device for controlling an alkalinity level of the aquatic application is depicted. The aquatic application 100 can be provided in the form of a swimming pool or spa 102 in fluid communication with one or more pool or spa components such as a pump 104, a filter 106, one or more pH/oxidation-reduction potential (ORP) probes 108, and a salt chlorinator 110. Generally, one or more conduits (not shown) may couple the swimming pool or spa 102 with the pump 104, the filter 106, the one or more pH/ORP probes 108, and the salt chlorinator 110. The conduits of the aquatic application 100 may form a closed circuit such that water flowing out of the swimming pool or spa 102 and provided to the one or more pool and spa components is returned to the swimming pool or spa 102. For example, water may circulate from the swimming pool or spa 102, flow to the pump 104, and then return to the swimming pool or spa 102. The pH/ORP probes 108 sense pH and ORP of the water of the swimming pool or spa 102 and the salt chlorinator 110 chlorinates the water of the swimming pool or spa 102.

The pump 104 may be designed to circulate the water into and out of the swimming pool or spa 102 and provide the water to the various components of the aquatic application 100. Portions of water can flow from the swimming pool or spa 102 and to a suction side of the pump 104. The pump 104 can provide a driving force for the pool water to flow through the other pool or spa components provided in the aquatic application 100. For example, the pump 104 can provide the driving force for the pool water flowing through the conduits (not shown) that fluidly couple the swimming pool or spa 102 to an alkalinity reagent tank 120.

The filter 106 may also be in fluid communication with the pump 104. The filter 106 may be designed to filter out unwanted substances and/or debris from the water of the swimming pool or spa 102. In certain instances, the filter 106 may be provided in the form of a pressure-fed sand filter, a gravity sand filter, a cartridge filter, a glass filter, an activated glass filter, a membrane filter, and other similar filters designed to remove unwanted substances and/or debris from water.

Referring still to FIG. 1, the one or more pH/ORP probes 108 may be designed to measure a pH value and/or an ORP value of the water of the swimming pool or spa 102. The one or more pH/ORP probes 108 may utilize electrodes to generate a voltage associated with either the hydrogen ion concentration (for the pH measurement) and oxidizing and reducing power (for the ORP measurement) of the water. The measured voltage is then converted into a pH value and/or an ORP value.

The salt chlorinator 110 may be designed to chlorinate the water of the swimming pool or spa 102. The salt chlorinator 110 may utilize an electrolytic cell to convert salt (i.e., sodium chloride) into chlorine, which in turn may form sanitizing compounds including hypochlorous acid and sodium hypochlorite. Thus, the salt chlorinator may provide the water of the swimming pool or spa 102 with disinfecting properties.

In some instances, as provided in FIG. 1, the aquatic application 100 may also include additional pool or spa components provided in the form of an acid dosing system 112, a controller 114, one or more valves (e.g., an electronic valve 116), a flow meter 118, the alkalinity reagent tank 120, and a total dissolved solids (TDS) sensor 122. One or more conduits may fluidly couple the electronic valve 116 to the flow meter 118, the pH/ORP probes 108, and/or the salt chlorinator 110. Furthermore, one or more conduits may place the flow meter 118 in fluid communication with the electronic valve 116 and the alkalinity reagent tank 120. The alkalinity reagent tank 120 may be in fluid communication with the flow meter 118, the TDS sensor 122, and the controller 114 via one or more conduits. Furthermore, one or more conduits may place the TDS sensor 122 in fluid communication with the alkalinity reagent tank 120 and the salt chlorinator 110. In addition, one or more conduits may position the acid dosing system 112 in fluid communication with the salt chlorinator 110.

The acid dosing system 112 may be provided in the form of a dosing mechanism designed to provide or dose one or more acidic chemicals (e.g., muriatic acid, sodium bisulfate) to the water of the swimming pool or spa 102. The one or more acidic chemicals may help control the pH level (and thus the water chemistry) of the swimming pool or spa 102. For example, the one or more acidic chemicals may be used to help maintain the pH level of the swimming pool or spa 102 within an acceptable range. In some instances, the acid dosing system 112 may help maintain the pH of the swimming pool or spa 102 within a range of about 7.0 to about 7.8 pH, or within a range of about 7.2 to about 7.6, or a range of about 7.4 to about 7.6.

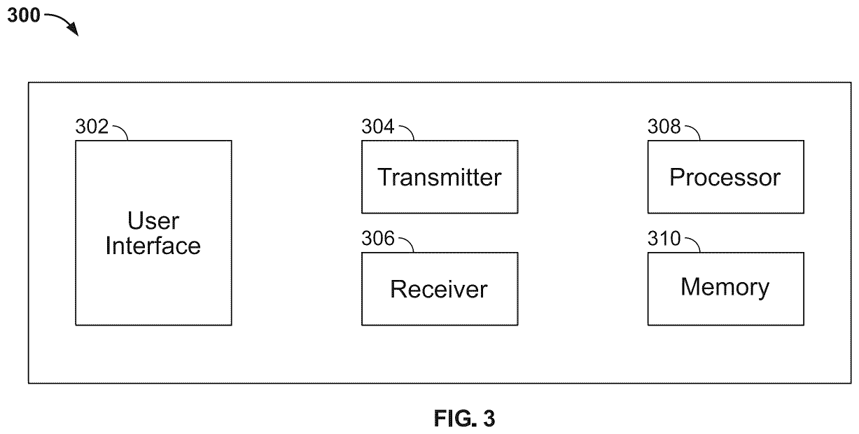

The various pool or spa components of the aquatic application 100 may be in electronic communication with the controller 114 and/or the other pool or spa components. For example, the controller 114, the pump 104, the one or more pH/ORP probes 108, the salt chlorinator 110, the acid dosing system 112, the electronic valve 116, the flow meter 118, the alkalinity reagent tank 120, and the TDS sensor 122 may each send and receive information via a wired connection or a wireless connection. In some instances, the wired connection may be provided in the form of ethernet connections, RS485 connections, and the like. In certain cases, the wireless connection may refer to a Local Area Network (LAN), a Wide Local Area Network (WLAN), Ultra Mobile Broadband (UMB), Institute of Electrical and Electronics Engineers (IEEE) 802.11 (Wi-Fi), IEEE 802.16 (WiMAX), IEEE 802.20, Flash-OFDM, a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein, to transmit and receive information. Additional details regarding the components of the controller 114 are discussed with reference to FIG. 3 below.

Referring again to FIG. 1, the electronic valve 116 may be provided in the form of an electrically controlled valve including, but not limited to, a ball valve, a gate valve, a butterfly valve, a solenoid valve, and other similar electronically controllable valves. In other instances, a pneumatically actuated or manually actuated valve may be used in the place of the electronic valve 116. The electronic valve 116 may be positioned upstream of the alkalinity reagent tank 120 and may be designed to control the flow of water to the alkalinity reagent tank 120. The electronic valve 116 may be provided with a local controller and/or may be in electrical communication with the controller 114. The local controller and/or the controller 114 may be configured to provide a signal to the electronic valve to trigger the opening and closing of the electronic valve 116. For example, if the electronic valve 116 is provided as a solenoid valve, the local controller or controller 114 may direct actuation of the electronic valve 116 by causing an application of an electric current to a solenoid of the electronic valve 116, which in turn creates a magnetic field that may actuate a plunger or armature within the electronic valve 116. The actuation of the plunger or armature may open or close the valve, allowing or stopping the flow of fluid through the electronic valve, thereby allowing or preventing the flow of water to one or more components of aquatic application that are positioned downstream of the electronic valve 116.

The flow meter 118 may be provided in the form of a mechanical flow meter (e.g., a turbine flow meter, a paddlewheel flow meter), an electronic flow meter (e.g., an ultrasonic flow meter, an electromagnetic flow meter), a differential pressure flow meter, and/or other similar flow meters. For example, the flow meter 118 may be provided as a cylindrical pipe coupled to one or more mechanical components (e.g., gears, rotors, impellers, turbines) designed to move in response to fluid flowing through the cylindrical pipe. The flow meter 118 may be designed to measure a rate at which an amount of water is flowing through the aquatic application 100 and/or particular components of the aquatic application. Further, the flow meter 118 may also determine the amount of water flowing through the flow meter and other components of the pool or spa 102.

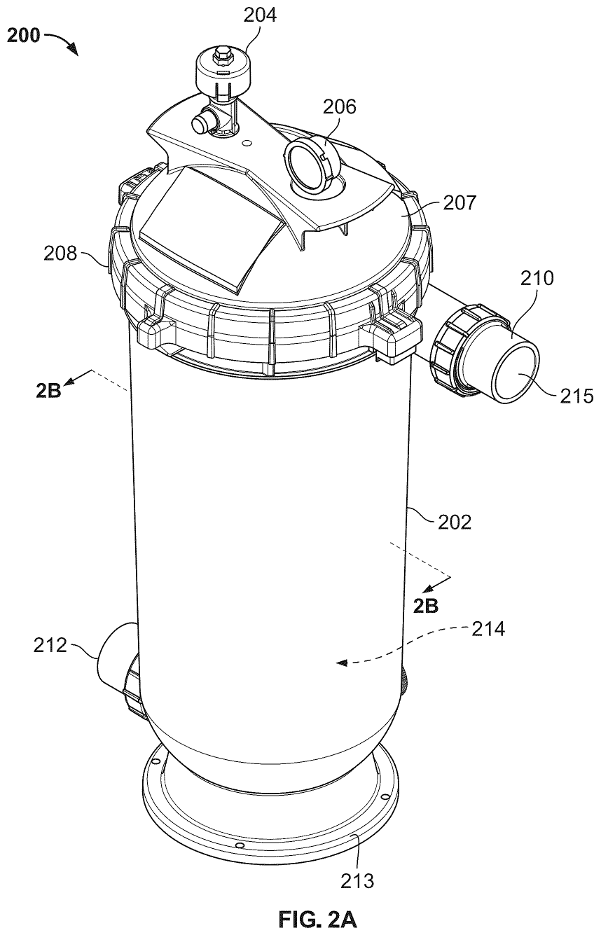

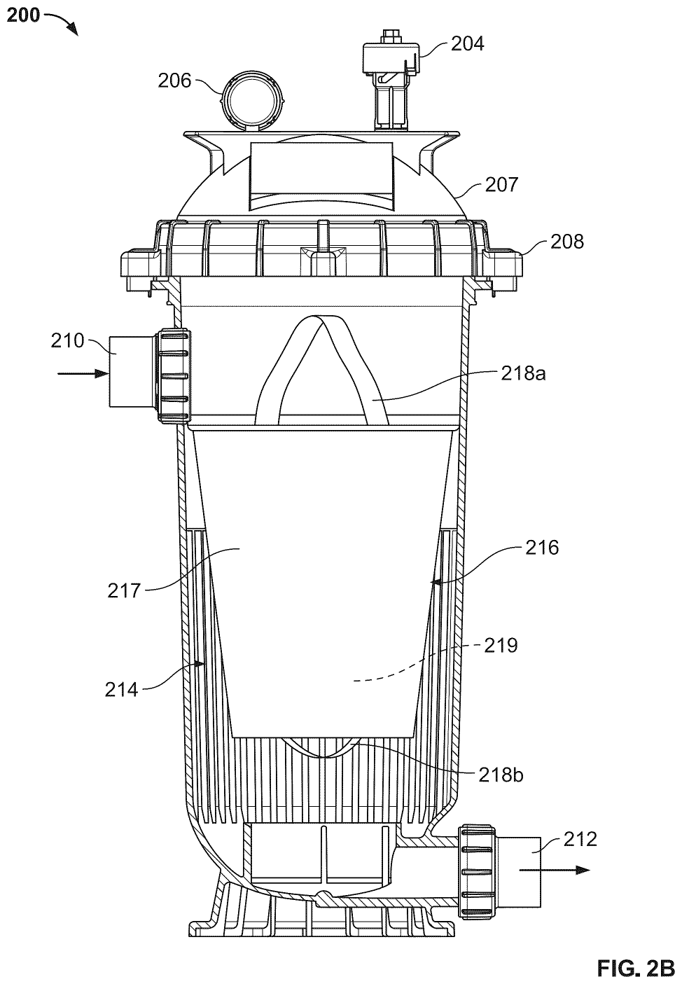

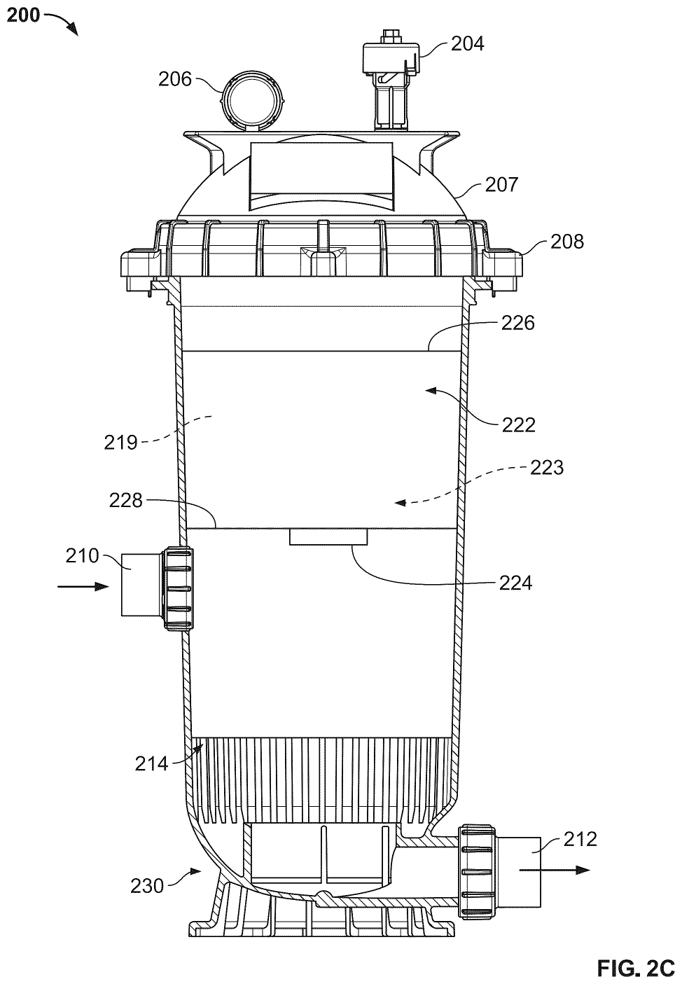

The alkalinity reagent tank 120 is designed to help control the alkalinity level of the aquatic application 100. The alkalinity reagent tank 120 is designed to retain one or more alkalinity agents that can be used to maintain, increase, and/or decrease the alkalinity level of the water of the swimming pool or spa 102. In certain instances, the alkalinity reagent tank 120 may provide or dose the alkalinity agent to the water of the swimming pool or spa 102 in response to an action of the acid dosing system 112. In some cases, the alkalinity reagent tank 120 may, in conjunction with a local controller or the controller 114, automatically provide or dose the alkalinity agent to the water of the swimming pool or spa 102. The structure and the functionality of the alkalinity reagent tank 120 is described in further detail with reference to FIGS. 2A-2C.

Referring still to FIG. 1, the TDS sensor 122 may be provided in the form of a conductivity TDS sensor, although the TDS sensor 122 may also be provided in other forms (e.g., an optical TDS sensor, a capacitive TDS sensor). The TDS sensor 122 may be defined by a probe including a pair of electrodes. The probe of the TDS sensor may be coupled to a local control system that includes a user interface and display, although the TDS sensor need not be provided with a local control system. For example, the user interface may include buttons to adjust the calibration values of the chemical levels in the water of the swimming pool or spa 102. The TDS sensor 122 may also be in communication with (and controlled by) the controller 114. The TDS sensor 122 may be designed to measure or determine a total concentration or amount of total dissolved solids (such as powder, salts, minerals, metals, etc.) present in the water of the swimming pool or spa 102.

In some instances, the aquatic application 100 may also include one or more additional sensors not specifically described herein. The one or more sensors may be designed to determine various water chemistry parameters associated with the water of the pool or spa (e.g., a pH level, an alkalinity level, a turbidity level, a TDS level, a free chlorine level, etc.). For example, the aquatic application 100 may include one or more sensors provided in the form of a colorimeter (not shown). The colorimeter may be placed at various locations in the aquatic application 100. The colorimeter may be designed to measure the concentrations of contaminants and/or other solutes dissolved in the water of the swimming pool or spa 102. Thus, measurements provided by the colorimeter may trigger the aquatic application 100 to activate or deactivate components of the swimming pool or spa 102, including the alkalinity reagent tank 120. In some instances, the colorimeter may be provided as the colorimeter described in Patent Application No. PCT/US2023/070300 owned by Pentair Water Pool and Spa, Inc., and incorporated herein by reference in its entirety.

In certain instances, the aquatic application 100 may be provided in the form of a spa and include components designed for use with a spa. In other instances, the aquatic application 100 may be provided in the form of a pool and a spa and include components that may be used with a pool and spa system. In yet other instances, the aquatic application 100 may be provided in the form of pool and/or spa components designed for use with a pool and/or a spa in a residential setting or a commercial setting. More particularly, the aquatic application 100 may be provided as a swimming pool, a hot tub, a spa, a plunge pool, and other recreational water venues not specifically discussed herein.

In certain instances, the aquatic application 100 could include additional components or fewer components than those described herein. Additionally, the components of the aquatic application 100 could be arranged in alternative configurations than the configurations and arrangements described herein.

Referring now to FIG. 2A, an alkalinity reagent tank 200 is shown. In some instances, the alkalinity reagent tank 200 may be provided as a vessel, a container, a reservoir, and/or other similar implements. In addition, the alkalinity reagent tank 200 may be the alkalinity reagent tank 120 of FIG. 1.

Generally, the alkalinity reagent tank 200 may be designed to help control the alkalinity level of the swimming pool or spa 102 of FIG. 1. Alkalinity is a measure of a water sample's ability to neutralize a known amount of acid. Controlling the alkalinity level of a pool or spa is important to help prevent undesired changes in the pH level of the water of the pool or spa caused by the introduction of acidic bodily matter to the water, such as urine and/or sweat.

Alkalinity may be measured in water using a variety of methods, including titrations, alkalinity test kits (e.g., alkalinity test strips), and pH meters. Titration alkalinity measurement is a traditional method that involves adding a measured amount of acid to a water sample until the alkalinity is neutralized. The endpoint can be determined by a color change or by titrating to a pH of 4.5. The volume of acid required to reach the endpoint is used to calculate the alkalinity level of the water sample. Additionally, a pH meter can be used to determine the endpoint of a titration.

Some test kits can simplify the process of measuring alkalinity by eliminating the need for additional equipment setup, calculations, and titrations. In addition, in some instances, the TDS level of the water of the pool or spa may be associated with the alkalinity level of the water.

The alkalinity reagent tank 200 may be designed to retain one or more alkalinity agents (e.g., sodium bicarbonate) and may provide a determined amount of the alkalinity agent to the water of the swimming pool or spa 102 of FIG. 1. Thus, the alkalinity reagent tank 200 may help control the alkalinity level of the pool or spa 102. As shown in FIG. 2A, the alkalinity reagent tank 200 is provided in the form of a body 202, an air relief valve 204, a pressure indicator 206, a lid 207, a lock ring 208, an inlet 210, an outlet 212, and a base 213. In certain instances, the alkalinity reagent tank 200 may be composed of a fiberglass-reinforced, chemical-resistant material, such as polypropylene, although the alkalinity reagent tank 200 may also be composed of other materials.

The body 202 may be provided in a substantially cylindrical shape, although the body 202 may also be provided in other shapes and forms. The body 202 may be substantially hollow and, together with the lid 207, define an interior 214 of the alkalinity reagent tank 200. The body 202 may retain the alkalinity agent and other internal components of the alkalinity reagent tank 200 therein. In certain instances, the body 202 may also be coupled to or be provided with the lid 207. In some instances, the lid 207 may be provided as a substantially dome-shaped cap, although the lid 207 may also be provided in other shapes or forms. For example, in certain instances, the lid 207 may have a substantially flat shape.

In certain instances, the alkalinity reagent tank 200 may be designed for easy access to the interior components of the alkalinity reagent tank 200 (e.g., a strainer). Thus, the interior components of the alkalinity reagent tank 200 may be removed (e.g., for maintenance) and/or the supply of the alkalinity agent in the alkalinity reagent tank 200 can be replenished. For example, the alkalinity reagent tank 200 may be provided with or integrally formed with the lock ring 208. The lock ring 208 may substantially circumscribe a body of the lid 207 and provide a leakproof seal when the lid 207 is coupled to the body 202. The lock ring 208 may be designed to selectively engage and disengage the body 202 via a twisting motion. Thus, the lid 207 may be selectively removed from the body to provide access to the internal components of the alkalinity reagent tank 200.

In some instances, the pressure indicator 206 may be designed to display the internal pressure of the body 202 of the alkalinity reagent tank 200. In some instances, the pressure indicator 206 may be provided in the form of a dial. A needle provided on or within the dial (not shown) may indicate the pressure inside the body 202 of the alkalinity reagent tank 200. Thus, the pressure indicator 206 may provide a user with a visual cue regarding when to use caution when opening the alkalinity reagent tank 200.

The inlet 210 may be coupled to or integrally formed with the body 202. The inlet 210 may be designed to provide fluid communication between the aquatic application 100 of FIG. 1 and the interior 214 of the alkalinity reagent tank 200. For example, the inlet 210 may be coupled to a conduit (not shown) of the aquatic application 100 that is designed to receive water from the swimming pool or spa 102. As shown, the inlet 210 may be substantially hollow, cylindrical, and extend outwardly and away from the body 202, although the inlet 210 may also be provided in other shapes and forms. The inlet 210 may also include an aperture 215 that allows for water from the aquatic application 100 to enter the body 202 and be provided to the interior 214. In the embodiment depicted, the inlet 210 extends outwardly from an upper portion of the body 202 adjacent and lid 207.

The outlet 212 may be coupled to or integrally formed with the body 202. The outlet 212 may be substantially hollow, cylindrical, and extended outwardly and away from the body 202, although the outlet 212 may be provided in other shapes and forms. Similar to the inlet 210, the outlet 212 may be designed to provide fluid communication between the aquatic application 100 of FIG. 1 and the interior 214 of the alkalinity reagent tank 200. Particularly, after water from the swimming pool or spa 102 is provided to the alkalinity reagent tank 200, the water may flow out of the interior via the outlet 212 and be provided back to the swimming pool or spa 102. As such, the outlet may also include an aperture (not shown) that allows for water to leave the body 202 and be provided to a conduit in fluid communication with the swimming pool or spa 102. As depicted, the outlet 212 extends outwardly from a lower portion of the body 202 adjacent the base 213.

Turning to FIG. 2B, the alkalinity reagent tank 200 may further include a strainer 216 disposed therein. The strainer 216 may be provided in the form of a container 217 coupled to and/or integrally formed with a top handle 218a and a bottom handle 218b that extend from opposing sides of the strainer 216. In certain cases, the container 217 may be provided as a substantially hollow, tapered cylinder, although the container 217 may also be provided in other shapes. In some instances, the container 217 may be primarily comprised of mesh, although the container 217 may also be provided in other forms. The mesh structure of the container 217 may allow for a solid (e.g., one or more alkalinity agents) to be retained in the container 217 while also allowing for water to flow therethrough. The container 217 may be designed to retain an alkalinity agent 219. For example, the alkalinity agent 219 may be placed within an interior of the container 217. In some instances, the alkalinity agent may comprise, consist essentially of, or consist of sodium bicarbonate (e.g., a sodium bicarbonate powder), although other agents or chemical compounds designed to control the alkalinity value of a swimming pool or spa may also be used.

The top handle 218a and the bottom handle 218b may each be substantially U-shaped, although the top handle 218a and the bottom handle 218b may also be provided in other forms. The handles 218a, 218b may provide a convenient location for a user to grip the strainer 216 when the strainer 216 is being positioned within or removed from the body 202 of the alkalinity reagent tank 200. In some instances, removal of the strainer 216 from the body 202 of the alkalinity reagent tank 200 may be necessary to refill, replenish, and/or replace the alkalinity agent 219. Additionally, removal of the strainer 216 from the body 202 may be necessary to clean and/or provide maintenance services to the interior 214 of the alkalinity reagent tank 200.

The alkalinity reagent tank 200 may be designed to provide the alkalinity agent 219 to water flowing through the alkalinity reagent tank 200. For example, when the reagent tank 200 is in use, the inlet 210 may receive water from the swimming pool or spa 102 of FIG. 1 through the flow meter 118 when the electronic valve 116 is operated in the open state. From the inlet 210, the water may flow into the container 217 of the strainer 216. Once the water is provided to the strainer 216, the water may be combined or mixed with the alkalinity agent 219 that is stored within the strainer 216. Then, a water-alkalinity agent mixture may flow through apertures (not shown) extending through a body of the container 217 and flow towards the bottom of the alkalinity reagent tank 200. The water-alkalinity agent mixture may then exit the alkalinity reagent tank 200 via the outlet 212 and be circulated to the pool or spa 102.

In some instances, the water flowing through the strainer may dissolve a portion of the alkalinity agent 219 in the strainer 216. In such instances, the water-alkalinity agent mixture may be a solution in which the alkalinity agent 219 is dissolved in the water. In other instances, some of the alkalinity agent 219 may leave the alkalinity reagent tank 200 without being dissolved. In such instances, the alkalinity-agent mixture may also comprise a suspension of the alkalinity agent 219 in the water.

The strainer 216 of the alkalinity reagent tank 200 may be imparted with a total holding capacity of about 1,500 grams to about 2,500 grams of the alkalinity agent 219, although the total holding capacity may be smaller or larger than these values. For example, the strainer 216 may be imparted with a total holding capacity of at least 1,500 grams, or at least 2,000 grams, or at least 2,100 grams, or at least 2,200 grams, or at least 2,300 grams, or at least 2,400 grams. As an additional example, the strainer 216 may be imparted with a total holding capacity of at least about 1,500 grams, or at least about 2,000 grams, or at least about 2,100 grams, or at least about 2,200 grams or at least about 2,300 grams, or at least about 2,400 grams, or at least about 2,500 grams.

Another instance of the alkalinity reagent tank 200 is provided in FIG. 2C. The alkalinity reagent tank 200 of FIG. 2C may have substantially the same functionality and share many of the same structural components the alkalinity reagent tank 200 provided in FIG. 2B. The alkalinity reagent tank 200 of FIG. 2C differs from the instance illustrated in FIG. 2B in that the alkalinity reagent tank 200 of FIG. 2C does not utilize a strainer 216 in the interior 214 of the alkalinity reagent tank 200. Instead, the alkalinity reagent tank 200 of FIG. 2C utilizes a receptacle 222 and a nozzle 224 to store and facilitate the release of the alkalinity agent 219 to the water of the swimming pool or spa 102. In addition, as compared to the alkalinity reagent tank 200 shown in FIG. 2B, the inlet 210 of the alkalinity reagent tank 200 shown in FIG. 2C has been relocated to accommodate the receptacle 222 and is disposed at about a midpoint of the body of the reagent tank 200.

The receptacle 222 may be provided in the form of a substantially hollow, tapered cylinder, although the receptacle 222 may also be provided in other shapes and forms. The receptacle may include a first end 226 and a second end 228 opposite of the first end 226. In some instances, the first end 226 may be open such that, when the lid 207 is removed from the body 202 of the alkalinity reagent tank 200, the receptacle 222 may be refilled and/or replenished with the alkalinity agent 219.

The nozzle 224 may be coupled to or integrally formed with the second end 228 of the receptacle 222. The nozzle 224 may extend downwardly and towards a bottom portion 230 of the alkalinity reagent tank 200. The nozzle 224 may be provided as a substantially hollow cylinder including an aperture (not shown) that can be selectively opened and closed, although the nozzle 224 may also be provided in other shapes and forms. When the nozzle 224 is open, the alkalinity agent 219 may be provided to the water flowing through the alkalinity reagent tank 200, whereas, when the nozzle 224 is closed, the alkalinity agent 219 may remain in the receptacle 222.

The inlet 210 may receive water from the swimming pool or spa 102 through the flow meter 118 when the electronic valve 116 is operated in an open state. As shown in FIG. 2C, water may flow from the inlet 210 into the interior 214 of the alkalinity reagent tank 200. The alkalinity agent 219 stored inside the receptacle 222 may be provided to the water by the nozzle 224. The nozzle 224 may be electronically controlled (i.e., open or closed) by a local controller associated with the alkalinity reagent tank 200 and/or the controller 114. For example, the alkalinity reagent tank 200 may have electronic circuitry designed to control or actuate the opening and closing of the receptacle 222 and/or the nozzle 224 to release the alkalinity agent 219 from the receptacle 222. After the alkalinity agent 219 has been provided to the water in the interior 214, the water may exit the alkalinity reagent tank 200 via the outlet 212. The water may then be provided back to the swimming pool or spa 102.

The receptacle 222 of the alkalinity reagent tank 200 may be imparted with a total holding capacity of about 1,500 grams to about 2,500 grams of the alkalinity agent 219, although the total holding capacity may be smaller or larger than these values. For example, the receptacle 222 may be imparted with a total holding capacity of at least 1,500 grams, or at least 2,000 grams, or at least 2,100 grams, or at least 2,200 grams, or at least 2,300 grams, or at least 2,400 grams. As an additional example, the receptacle 222 may be imparted with a total holding capacity of at least about 1,500 grams, or at least about 2,000 grams, or at least about 2,100 grams, or at least about 2,200 grams or at least about 2,300 grams, or at least about 2,400 grams, or at least about 2,500 grams.

The alkalinity reagent tank 200 of FIGS. 2A-2C may be in electronic communication with one or more controllers (e.g., the controller 114). The controller 114 may determine an amount of the alkalinity agent 219 to be mixed with the water provided to the alkalinity reagent tank 200. The controller 114 may also transmit the determined amount to the electronic circuitry of the alkalinity reagent tank 200. For example, the alkalinity reagent tank 200 may selectively release the determined amount of the alkalinity agent 219 from the receptacle 222 through the nozzle 224. For instance, the alkalinity reagent tank 200 may be in communication with the interior 223 of the receptacle 222 such that the alkalinity agent 219 may be provided from the interior 223 of the receptacle 222 to the water flowing through the alkalinity reagent tank 200.

The following is an example operation that may be used to provide the alkalinity agent 219 to water of the swimming pool or spa 102. To begin, as water flows through the alkalinity reagent tank 200 as shown in FIG. 2C, the controller 114 may open the receptacle 222 and/or the nozzle 224 to release the alkalinity agent 219. As will be further described below, the controller 114 may also determine an amount of alkalinity agent 219 that is to be provided to the water. The controller 114 may then direct the alkalinity reagent tank 200 to provide the amount of the alkalinity agent 219. For example, if the controller 114 determines that 340 grams (0.75 pounds) of the alkalinity agent 219 should be mixed with the water of the swimming pool or spa 102, the alkalinity reagent tank 200 may then direct the receptacle 222 and/or the nozzle 224 to release the determined amount of alkalinity agent 219 (i.e., 340 grams (0.75 pounds)).

When the determined amount of the alkalinity agent 219 is released from the receptacle 222, the alkalinity agent 219 may mix with water inside the alkalinity reagent tank 200. In this example, the alkalinity agent 219 released from the receptacle 222 is first combined with the water entering the alkalinity reagent tank 200 from the inlet 210 since the receptacle 222 is positioned above the inlet 210. As the water flows through the alkalinity reagent tank 200, the alkalinity agent 219 dissolves in the water, and the water-alkalinity agent mixture exits the alkalinity reagent tank 200 through outlet 212. After the determined amount of the alkalinity agent 219 is released from the receptacle 222, the alkalinity reagent tank 200 and/or the controller 114 closes the receptacle 222 to prevent additional alkalinity agent 219 from being released from the receptacle 222.

The alkalinity reagent tank 200 may be provided with a sensor (not shown) designed to measure or determine the amount of the alkalinity agent 219 released from the receptacle 222. For example, the sensor may be provided as a mass sensor that can determine the amount of alkalinity reagent remaining in the container 217 or the receptacle 222. In some instances, the TDS sensor 122 may determine the amount of the alkalinity agent 219 provided from the container 217 or the receptacle 222. In some cases, the alkalinity agent 219 may be provided to the water at a predetermined rate (e.g., at a rate of about 50 grams per second). In such instances, the controller 114 may determine a duration for which the alkalinity agent 219 is provided to the water. For example, the controller 114 may determine that the receptacle 222 and/or the nozzle 224 should remain open for the determined amount of time, after which the receptacle and/or the nozzle 224 are closed.

The alkalinity agent 219 may be stored in the alkalinity reagent tank 200 in various forms, e.g., as a solid, a liquid, or a solution. For example, the alkalinity agent 219 may be stored in the strainer 216 of FIG. 2B or in the receptacle 222 of FIG. 2C in slurry form. As an additional example, the alkalinity agent 219 may be stored in the receptacle 222 of FIG. 2C as a dry powder. In certain instances, the alkalinity agent 219 may be stored in the alkalinity reagent tank 200 in the form of a concentrated solution.

Turning now to FIG. 3, a block diagram of a controller 300 of an aquatic application is shown. In some instances, the controller 300 may be utilized as the controller 114 of FIG. 1 or any local controller of the one or more components of the aquatic application of FIG. 1.

The controller 300 may include electronic components such as one or more user interfaces 302, a transmitter 304, a receiver 306, a processor 308, and a memory 310. The controller 300 may be able to download, store, and/or execute software having computer-executable instructions. The software may include one or more modules. The one or more modules may include, for example, algorithms to monitor and/or store the measurements or other data received from one or more of the components of the aquatic application 100, including any sensors, valves, tanks, and/or pumps provided in the aquatic application 100. In addition, the controller 300 may monitor and/or store real-time and historic flow patterns and usage data. The controller 300, via the one or more modules, may also perform calculations or other data analysis or modeling processes to determine various outcomes. The outcomes may include, for example, turning one or more of the components of the aquatic application 100 on or off, actuating the one or more valves provided in the aquatic application 100, providing a determined amount of an alkalinity agent to a pool or spa, and/or placing one or more of the components of the aquatic application 100 in standby mode.

The controller 300 may be Bluetooth enabled and have Internet of Things (IoT) connectivity. The one or more components of the aquatic application (e.g., the sensors, valves, and/or pump) may be IoT-enabled and/or communicatively connected smart components.

The controller 300 may be electronically connected to the user interface 302 and one or more components of the aquatic application 100 (e.g., the sensors, valves, tanks, pumps). For example, the controller 300 may be placed in electronic communication with the user interface 302 and the one or more components of the aquatic application 100 via one or more wires or via a communications network. In some instances, the communications network may be a wireless network such as a personal area network (PAN) or local area network (LAN), a cellular network, or the Internet. In some embodiments, the user interface may be an LED screen, an LCD screen, an OLED display, a cell phone, a laptop computer, and/or other similar devices.

The user interface 302 may be configured to enable a user (not shown) to manually input a value of the alkalinity level of the swimming pool or spa 102. The user interface 302 is also configured to display a determined amount of sodium bicarbonate powder that should be mixed with water, an open state, or a closed state of the electronic valve 116, and the value of TDS received from the TDS sensor 122, etc. as explained above.

In some instances, the controller 300 may be able to self-diagnose or troubleshoot problems that arise without input from one of the various components or a user. Artificial Intelligence (AI) or Machine Learning (ML) may be used to learn different patterns of usage to predict future behavior.

In some instances, the one or more modules may include a training module that may be designed to execute instructions related to one or more data analysis and modeling processes. In some embodiments, the training module may generate and iteratively train the machine learning training model to provide dynamic data analysis and outcomes, and the advanced analytics may be used to perform system and/or component diagnostics, generate alerts, notifications, or action items, provide customized recommendations according to user or service provider settings or preferences, and similar processes.

In some instances, one or more metrics or characteristics (e.g., historic water usage data, system pressure, TDS concentration, alkalinity agent usage, and/or water flow rates) may be used as parameters in one or more processes to iteratively train a training model or a plurality of machine learning training models. It is to be understood that processes for “iteratively training the machine learning training model” may include machine learning processes, artificial intelligence processes, and other similar advanced machine learning processes. In various instances, the iteratively trained machine learning model(s) can be designed to perform various advanced data analysis and modeling processes. In some embodiments, these processes can be performed by multiple machine learning models, or multiple aspects of a single machine learning model (e.g., an ensemble model), or a combination thereof. In one non-limiting example, the machine learning training model(s) can be designed to generate, train, and execute a plurality of nodes, neural networks, gradient boosting algorithms, mutual information classifiers, random forest classifications, and other machine learning and artificial intelligence-related algorithms. It will be appreciated that the system and processes described herein can include different and/or additional details, data, measurements, parameters, metrics, and/or characteristics than those described herein.

The transmitter 304 may be designed to transmit one or more signals to the one or more components of the aquatic application 100. For example, the transmitter 304 may be designed to transmit one or more signals to the electronic valve 116 to operate the electronic valve 116 in the open state or the closed state, as explained above with reference to FIG. 1. In addition, the transmitter 304 may be configured to transmit the determined amount of alkalinity agent 219 to the alkalinity reagent tank 200, as explained with reference to FIG. 2B. The transmitter 304 may be also be configured to transmit a signal to the electronic valve to operate in a closed state in response to an indication received from the alkalinity reagent tank 200, as explained in further detail with reference to the methods below.

The receiver 306 may be designed to receive information from the one or more components of the aquatic application 100. For example, the receiver 306 may be designed to receive information associated with the open state or the closed state of the electronic valve 116, to receive a measured TDS value from the TDS sensor 122, and/or the value associated with the amount of water flowing through the flow meter 118. The receiver 306 may also be designed to receive an indication from the alkalinity reagent tank 200 associated with releasing the determined amount of alkalinity agent 219 from the strainer 216 and/or the receptacle 222.

The processor 308 may be designed to determine one or more actions associated with the functions of the one or more components of the aquatic application 100. For example, the processor 308 may be designed to determine an amount of alkalinity agent 219 to be mixed with water of the swimming pool or spa 102. As an additional example, the processor 308 may be designed to determine if the concentration of alkalinity agent 219 combined with the water exiting the alkalinity reagent tank 200 matches the determined amount of alkalinity agent 219 based on the one or more values of TDS.

The memory 310 may be designed to store and/or save historical and real-time performance information and/or sensor information provided to the controller 300 by one or more components of the aquatic application 100. For example, the memory 310 may be designed to store and/or save the determined amount of alkalinity agent 219, the value of the TDS received from the TDS sensor 122, the open state or the closed state of the electronic valve 116, the value of the alkalinity level of the swimming pool or spa, and any other similar information provided to the controller 300 by the one or more components of the aquatic application 100.

In some examples, the processor 308 may refer to a single-core processor, a dual-core processor, a quad-core processor, a hexacore processor, an octa-core processor, a deca-core processor, and/or any other processor known in the art, including future processors not explicitly mentioned herein.

In some examples, the memory 310 may refer to a random access memory (RAM), read-only memory (ROM), a flash memory, and/or any other memory known in the art, including future memory systems not explicitly mentioned herein.

The controller 300 may also receive a value associated with an amount of acid dosed or provided to the swimming pool or spa 102 from the acid dosing system 112. Based on the value of the amount of acid dosed into the swimming pool or spa 102, the controller 300 may determine an amount of the alkalinity agent 219 (e.g., sodium bicarbonate powder, NaHCO₃) to be mixed with the water of the swimming pool or spa 102. In particular, the controller 300 may determine an amount of alkalinity agent 219 that should be mixed with the water in proportion to the amount of acid being dosed into the swimming pool or spa 102 by the acid dosing system 112. In some instances, the controller 300 may determine an amount of sodium bicarbonate powder (in pounds) to provide to the water for every ounce of acid dosed to the water of the swimming pool or spa 102. For example, if “full strength acid” (e.g., a 31.45% hydrochloric acid solution) provided by the acid dosing system 112 to a 5,000-gallon swimming pool or spa, then for every 1 ounce of acid added to the swimming pool or spa, approximately a 1 ppm drop in the alkalinity value of the pool or spa is expected. In this case, about 0.075 pounds of sodium bicarbonate powder should be added to the 5,000-gallon pool or spa to offset the change in the alkalinity value caused by the addition of the 1 ounce of full strength acid.

A user or a technician may also utilize the user interface 302 of the controller 300 to set a predetermined value of a dose of the alkalinity agent 219 for each ounce of acid provided to the swimming pool or spa 102. In some instances, the controller 300 can recommend settings to the user or provide step-by-step instructions regarding how to determine the correct alkalinity agent dose setting for the swimming pool or spa 102.

The controller 300 may transmit a signal to the electronic valve 116 to operate in the open state, thereby allowing the water to be mixed with a determined amount of alkalinity agent 219 in proportion to the amount of acid provided to the water of the swimming pool or spa 102. The controller 300 may also transmit the determined amount of the alkalinity agent 219 to the alkalinity reagent tank 200 to release the determined amount of alkalinity agent 219 from the receptacle 222.

The controller 300 may work in conjunction with, or independent of, one or more local controllers associated with the one or more pool components (e.g., the pump 104, the salt chlorinator 110, acid dosing system 112, the alkalinity reagent tank 200) disclosed herein. For conciseness, the systems and methods of FIGS. 1, 2, 4-7 reference a controller (i.e., the controller 114, 300), although the one or more functions described in the methods may also be performed by one or more of the controllers 300 and one or more local controllers associated with the device(s) described herein. Alternatively, one or more local controllers associated with the pool components may work in conjunction with, or independent from, the controller 300 to effectuate the operational modes and other methods described herein.

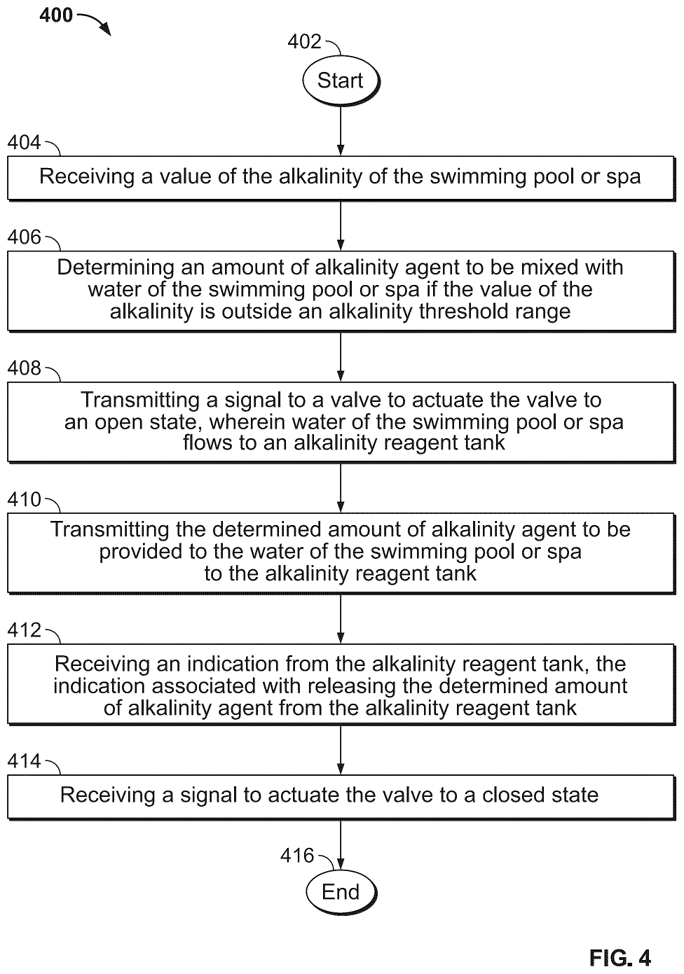

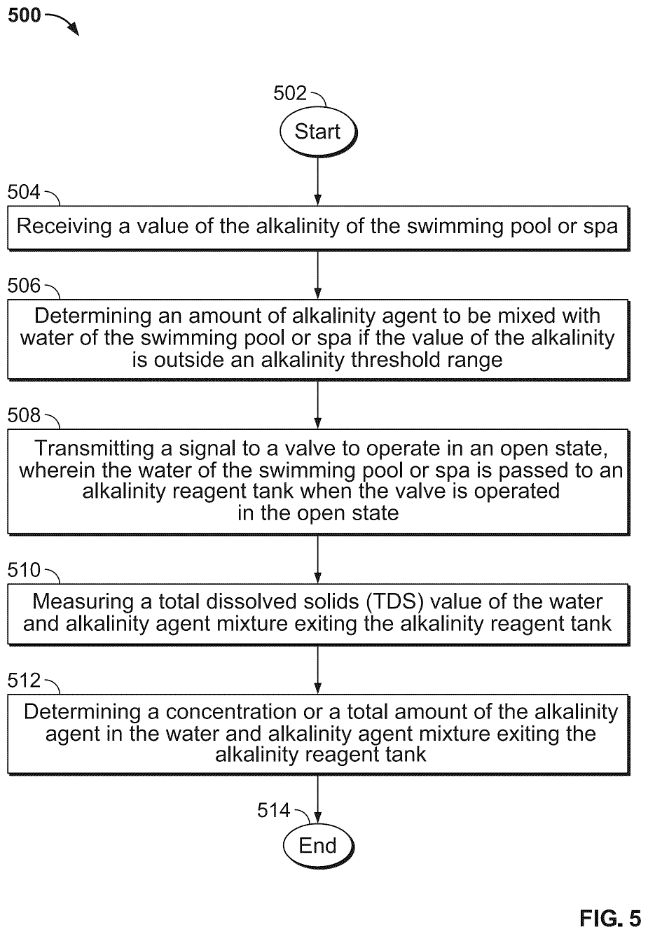

It is to be understood that one or more of the values associated with the methods of FIGS. 4-5 (e.g., an alkalinity value, a TDS value) may be measured and provided to the controller 114 at different time intervals. The one or more values described with reference to methods disclosed herein may be measured on demand, manually implemented, or at predetermined time intervals (e.g., continuously, once a second, once a minute, once a day, once a week, once a month, etc.). Further, it is to be understood that the one or more of the values associated with the methods disclosed herein may be measured more than once. For example, a first measurement of the one or more values may be carried out at a first time period followed by a second measurement carried out at a second time period, where the amount of time that elapses between the first time period and the second time period is determined by the predetermined time interval or another predetermined operational condition. In each instance, such measurements may be carried out by one or more systems provided with the aquatic application 100 and then received and stored by a controller (e.g., the controller 114 of FIG. 1 and/or the local controllers of the pool components of the aquatic application 100 of FIG. 1).

In addition, the predetermined values, thresholds, ranges, and other information described with reference to the methods disclosed herein may be manually implemented or otherwise input into the system. For example, the predetermined values and predetermined ranges may be manually input into a user interface of a controller (e.g., the controller 300 and/or the local controllers of the pool components of the aquatic application 100 of FIG. 1), provided to the controller via a user device that is in communication with the controller or otherwise associated with and retained by the controller 300.

In some instances, a lookup table of predetermined values, thresholds, ranges, and other information may be stored by a controller (e.g., the controller 114 and/or the local controllers of the pool components of the aquatic application 100 of FIG. 1), and the controller may determine an appropriate action based on one or more of the variables discussed herein. In addition, the controller may include pre-stored lookup tables. Furthermore, the controller 300 may be in communication with a network (e.g., a cloud network) and may be capable of downloading lookup tables. The controller 300 may select threshold values (e.g., a threshold alkalinity value) from the lookup tables based on a number of factors including the pH, turbidity, free chlorine content, ORP value, and/or other parameters.

Referring now to FIG. 4, a method 400 for controlling an alkalinity level of a swimming pool or spa is provided. The method 400 may be implemented with the aquatic application 100 of FIG. 1 and may utilize any alkalinity reagent tank 200 and associated components, and variations thereof, disclosed herein.

The method 400 may start at a step 402. At a step 404, a controller receives a current alkalinity value of the water of the swimming pool or spa. The alkalinity value may be determined via a measurement of the alkalinity level of the water of the pool or spa. For example, various manners of determining the alkalinity value are described with reference to a step 504 of a method 500 described with reference to FIG. 5. As an additional example, the alkalinity value of the water may be determined as previously described in the discussion with reference to FIGS. 2A-2C.

At a step 406, the controller determines whether the measured alkalinity value is within an alkalinity threshold range. If the measured alkalinity value is within the alkalinity threshold range, then the controller takes no further action, as a determined amount of alkalinity agent to be provided to the water is zero or about zero. Thus, in such instances, the method may end at the step 406. If the alkalinity value is outside the alkalinity threshold range, then the controller determines an amount of an alkalinity agent (e.g., sodium bicarbonate) to be provided to or mixed with water from the swimming pool or spa. In certain instances, the determined amount may be based on the measured alkalinity value. Various manners of determining an amount of alkalinity agent to be provided to or mixed with water described above or described in step 506 of FIG. 5 below may also be utilized at this step.

In some instances, the controller may utilize an alkalinity threshold range that is about 80 parts per million (ppm) to about 120 ppm, although the alkalinity threshold range may also be less than or greater than these values. For example, the alkalinity threshold range may be 80 ppm to 120 ppm, or 90 ppm to 110 ppm, or 100 ppm to 105 ppm. As an additional example, the alkalinity threshold range may be about 80 ppm to about 120 ppm, or about 100 ppm to about 110 ppm, or about 100 ppm to about 105 ppm. In some instances, the controller may utilize an alkalinity threshold range that is bound by any minimum value and any maximum value as described above.

At a step 408, the controller transmits a signal to a valve to actuate the valve to an open state or an open configuration. In some instances, when the valve is in the open state, the water of the swimming pool or spa may flow through the flow meter. The water may then exit the flow meter and then flow to the alkalinity reagent tank. In certain instances, the valve may be provided in the form of an electronic valve. In certain cases, the flow meter may not be provided, and water may instead flow directly from the valve and to the alkalinity reagent tank.

At a step 410, the controller transmits the determined amount of alkalinity agent to be provided to or mixed with water to the alkalinity reagent tank. As explained with reference to FIGS. 2A-2C, the determined amount of alkalinity agent is dosed to the water flowing through the alkalinity reagent tank and combined with the water of the swimming pool or spa.

At a step 412, the controller receives an indication from the alkalinity reagent tank associated with releasing the determined amount of the alkalinity agent from the alkalinity reagent tank. For example, the controller may receive the indication (such as a signal, a notification, a message, etc.) from the electronic circuitry of the alkalinity reagent tank when a sensor of the alkalinity reagent tank senses, measures, or determines that the determined amount of the alkalinity agent has been released.

At a step 414, the controller transmits a signal to the valve to actuate the valve to a closed state or configuration. In some instances, the signal from the controller is transmitted when the controller receives the indication from the alkalinity reagent tank that the determined amount of the alkalinity agent has been released from the alkalinity reagent tank (e.g., from the receptacle or strainer).

The method 400 ends at a step 416.

In some instances, after a predetermined time, the method 400 will restart at step 402. In other instances, another predetermined parameter (e.g., a measured or input alkalinity value) may be used to reinitiate the method 400 at the step 402.

In some instances of the method 400, the measured alkalinity value can be determined at a first time period and the alkalinity agent can be dosed to the water of the swimming pool or spa at a second time period. In some instances, the second time period is after the first time period. In some cases, the measured alkalinity value can be determined at a first time period, the measured alkalinity value can be compared to the threshold alkalinity range at a second time period, and the alkalinity agent can be dosed to the water of the swimming pool or spa at a third time period. In some such cases, the first time period is before the second time period, and the third time period is either at substantially the same time or after the second time period.

Referring now to FIG. 5, a method 500 for controlling the alkalinity level of a swimming pool or spa is provided, according to another example of the present disclosure. The method 500 may be implemented with the aquatic application 100 of FIG. 1 and may utilize any of the alkalinity reagent tanks, the associated components and routines, and variations thereof disclosed herein.

The method 500 starts at a step 502. At a step 504, the controller receives an alkalinity value of water of the swimming pool or spa. The alkalinity value may be determined via a measurement of the alkalinity level of the water of the pool or spa. In some instances, the alkalinity level of the swimming pool or spa is measured manually by a user or other person (e.g., dealer, user, pool servicer, and the like). As an example, a water test strip may be used to measure the alkalinity level of the swimming pool or spa. Further, this measured alkalinity value may be recorded at the dosing controller via a user interface. In other instances, the alkalinity level of the swimming pool or spa is automatically measured using an alkalinity sensor and communicated to the controller. In other instances, the alkalinity level of the swimming pool or spa is automatically determined by a software application either executed at the controller or a mobile device of the user of the swimming pool or spa. In instances where the alkalinity level of the swimming pool or spa is automatically determined by the mobile device, the mobile device may communicate the measured alkalinity value to the controller. As an additional example, the alkalinity value of the water may be determined as previously described in the discussion with reference to FIGS. 2A-2C.

At a step 506, the controller determines whether the measured alkalinity value is within an alkalinity threshold range. If the alkalinity value is within the alkalinity threshold range, then the controller takes no further action, as a determined amount of alkalinity agent to be provided to the water is zero or about zero. Thus, in such instances, the method 500 may end at the step 506. If the alkalinity value is outside the alkalinity threshold range, then the controller determines an amount of an alkalinity agent to be provided to or mixed with water of the swimming pool or spa. The amount of alkalinity agent to be provided to or mixed with water may be based on the measured alkalinity value. For example, the amount of sodium bicarbonate powder to be mixed with water may be determined using the following formula: baking soda (in pounds) to be added=a volume of swimming pool or spa (gallons)×alkalinity (in ppm) increase needed×0.000015. As an additional example, the amount of sodium bicarbonate powder to be mixed with water may be determined using the following formula: baking soda (in grams) to be added=a volume of swimming pool or spa (gallons)×alkalinity (in ppm) increase needed×0.0068.

As a non-limiting example, if the measured alkalinity value is 70 ppm, the alkalinity threshold range has a lower bound of 80 ppm (resulting in a needed alkalinity increase of at least 10 ppm), and the volume of the swimming pool or spa is 5000 gallons, the controller may determine that 340 grams (or 0.75 pounds) of the sodium bicarbonate powder should be provided to or mixed with the water to maintain the alkalinity level of the swimming pool or spa within the alkalinity threshold range.

In some instances, the controller may utilize an alkalinity threshold range that is about 80 parts per million (ppm) to about 120 ppm, although the alkalinity threshold range may also be lesser or greater than these values. For example, the alkalinity threshold range may be 80 ppm to 120 ppm, or 90 ppm to 110 ppm, or 100 ppm to 105 ppm. As an additional example, the alkalinity threshold range may be about 80 ppm to about 120 ppm, or about 100 ppm to about 110 ppm, or about 100 ppm to about 105 ppm. In some instances, the controller may utilize an alkalinity threshold range that is bound by any minimum value and any maximum value as described above.

At a step 508, the controller transmits a signal to a valve to actuate the valve to an open state or configuration if the alkalinity value of the swimming pool or spa is outside the alkalinity threshold range. In some instances, when the valve is in an open state, the water of the swimming pool or spa may flow through the flow meter. The flow meter may measure the rate at which the water is flowing. The water may then exit the flow meter and flow to the alkalinity reagent tank. The alkalinity reagent tank may store an alkalinity agent such as sodium bicarbonate. In the alkalinity reagent tank, the water may be combined with the alkalinity agent. The water that is combined with the alkalinity agent (i.e., the water and alkalinity agent mixture) may then exit the alkalinity reagent tank.

At a step 510, the TDS sensor may identify a value of total dissolved solids (TDS) of the water and alkalinity agent mixture exiting the alkalinity reagent tank. The identified value may be communicated by the TDS sensor to the controller. In some instances, more than one TDS value may be determined by the TDS sensor. In such instances, the identified values of the TDS may comprise a first TDS value and a second TDS value. The first TDS value may be received at a first time period and the second TDS value may be received at a second time period.

At a step 512, the controller may determine the concentration of or a total amount of the alkalinity agent in the water-alkalinity agent mixture exiting the alkalinity reagent tank. In some instances, the controller can determine the concentration of or a total amount of the alkalinity agent in the water-alkalinity agent mixture by multiplying a value representative of an average flow of the water through the flow meter and a TDS value received from the TDS sensor. In other instances, a first TDS value associated with the water in the swimming pool or spa and a second TDS value associated with water exiting the alkalinity reagent tank are measured and/or identified by one or more TDS sensors and communicated to the controller. In this scenario, the controller subtracts the second TDS value from the first TDS value to determine a precise TDS value associated with the concentration or total amount of the alkalinity agent added to the water by the alkalinity reagent tank.

In addition, the controller may determine if the concentration of or the total amount of alkalinity agent in the water of the swimming pool or spa exiting the alkalinity reagent tank corresponds to the determined amount of alkalinity agent to be provided to or combined with the water of the swimming pool or spa (i.e., as determined at the step 506). If the concentration of the alkalinity agent added to the water of the swimming pool or spa corresponds to, or substantially corresponds to within an acceptable error tolerance, the determined amount of alkalinity agent (i.e., if the concentration or total amount of alkalinity agent provided to the water is substantially equal to the determined amount of alkalinity agent), then, the controller may determine that the alkalinity level of the swimming pool or spa is now controlled. If the concentration of the alkalinity agent in the water of the swimming pool or spa does not correspond to, or is outside of the acceptable error tolerance, the determined amount of alkalinity agent (i.e., if the concentration or total amount of alkalinity agent provided to the water is not substantially equal to the determined amount of alkalinity agent), may indicate that the alkalinity level of the swimming pool or spa is still outside the alkalinity threshold range and should be further controlled. In such instances, the method 500 may restart at the step 502, or the step 504, or the step 506.

The controller may determine that the concentration or total amount of alkalinity agent provided to the water is substantially equal to the determined amount of alkalinity agent if the difference between the two values is no more than about 5% (e.g., the acceptable error tolerance), although the difference between the two values may also be somewhat greater than about 5%. For example, the controller may determine that the concentration or total amount of alkalinity agent provided to the water is substantially equal to the determined amount of alkalinity agent if the difference between the two values is no more than about 5%, or no more than about 4%, or no more than about 3%, or no more than about 2%, or no more than about 1%, or no more than about 0%, or if the two values equal each other.

The method 500 ends at a step 514.

In some instances, the valve may be operated in the open state for a first predetermined period of time at the step 508 of the method 500. Then, the controller may transmit a signal to the valve to operate the valve in a closed state after the first predetermined period of time has elapsed. In some such instances, the controller may transmit the signal to the valve irrespective of whether the concentration or total amount of the alkalinity agent mixed in the water of the swimming pool or spa matches with the determined amount of alkalinity agent. As such, in this example, the valve may be operated in the closed state, after the first predetermined period of time has elapsed, independent of or before receiving the TDS value from the TDS sensor.

In some instances, when the valve is operated in the closed state (e.g., after the predetermined period of time has elapsed), the controller may receive a TDS value from the TDS sensor. The controller may then determine if the concentration or total amount of the alkalinity agent in the water exiting the alkalinity reagent tank is substantially equal to the determined amount of alkalinity agent. If the concentration or the total amount of the alkalinity agent in the water exiting the alkalinity reagent tank is not substantially equal to the determined amount of alkalinity agent, the controller may determine that the valve should again be operated in the open state for a second predetermined period of time. By operating the valve in the open state for the second predetermined period of time, the alkalinity level of the swimming pool or spa may be further controlled such that the alkalinity level of the swimming pool or spa is brought inside the alkalinity threshold range.

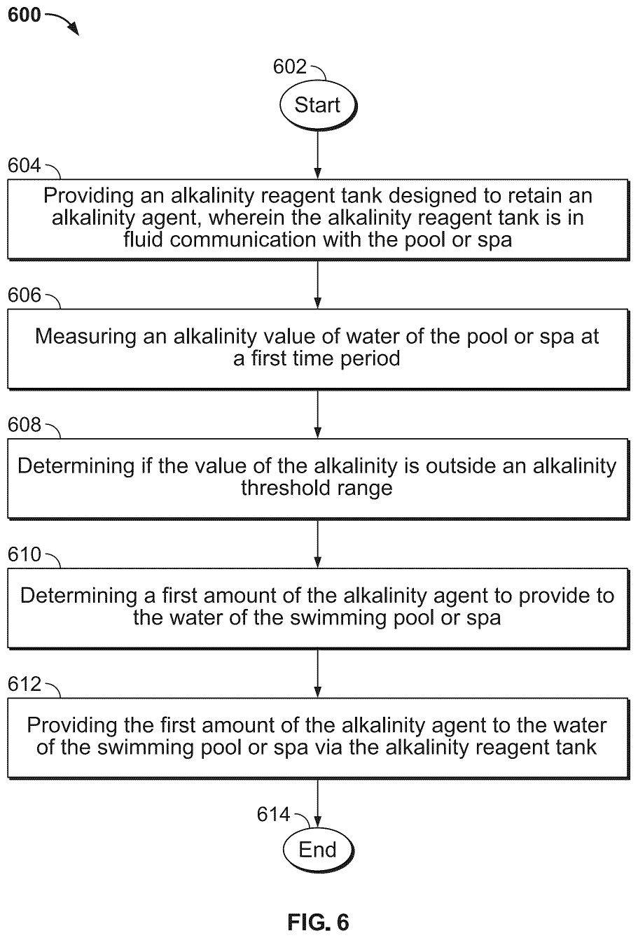

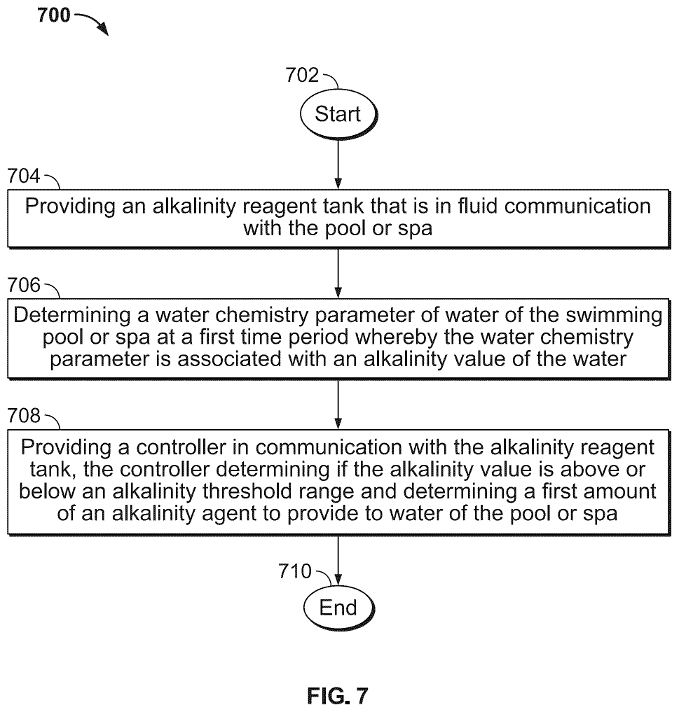

The methods of FIGS. 6 and 7 are alternative methods for controlling alkalinity of a pool or spa. The methods of FIGS. 6 and 7 may utilize any of the steps of the methods 400 and 500 discussed with reference to FIGS. 4 and 5, to the extent such steps are not already utilized in the methods of FIGS. 6 and 7.

Referring now to FIG. 6, a method 600 for controlling an alkalinity value of a swimming pool or spa is provided. The method 600 may be utilized with the aquatic application 100 of FIG. 1 and may utilize any of the alkalinity reagent tanks, associated components and routines, and variations thereof disclosed herein.

The method 600 starts at a step 602. At a step 604, an alkalinity reagent tank is provided. The alkalinity reagent tank may be designed to retain an alkalinity agent. Additionally, the alkalinity reagent tank may be in fluid communication with the pool or spa.

At a step 606, an alkalinity value of water of the pool or spa may be measured. The alkalinity value of the water may be measured at a first time period. In some instances, a human may manually measure the alkalinity value of the swimming pool or spa.

At a step 608, the controller may determine whether the alkalinity value is outside an alkalinity threshold range. If the alkalinity value is within the alkalinity threshold range, then the controller may take no further action. If the alkalinity value is outside the alkalinity threshold range, then the controller may determine an amount of an alkalinity agent to be provided to or mixed with water from the swimming pool or spa.

At a step 610, the controller may determine a first amount of the alkalinity agent to provide to the water of the swimming pool or spa.

At a step 612, the controller may provide the first amount of the alkalinity agent to the water of the swimming pool or spa using the alkalinity reagent tank.

The method 600 ends at a step 614.

In some instances, after a predetermined time, the method 600 may restart at the step 602. In other instances, another predetermined parameter (e.g., a measured alkalinity value or an alkalinity value provided to the controller) may be used to reinitiate the method 600 at the step 602.

Referring now to FIG. 7, a method 700 for controlling the alkalinity level of a swimming pool or spa is provided. The method 700 may be utilized with the aquatic application 100 of FIG. 1. The method 700 may utilize any of the alkalinity reagent tanks, components, routines, and variations thereof disclosed herein.

The method starts at a step 702. At a step 704, an alkalinity reagent tank that is in fluid communication with the pool or spa may be provided.

At a step 706, a human or a controller may determine a water chemistry parameter of water of the swimming pool or spa at a first time period. The water chemistry parameter may be associated with an alkalinity value of the water. In some instances, the water chemistry parameter may be determined by a sensor associated with the swimming pool or spa.

At a step 708, a controller in communication with the alkalinity reagent tank may be provided. The controller may determine whether the alkalinity value is above or below an alkalinity threshold range. The controller may also determine a first amount of an alkalinity agent to provide to water of the pool or spa. If the alkalinity value is within the alkalinity threshold range, the controller may take no further action. If the alkalinity value is outside the alkalinity threshold range, then the controller may determine an amount of an alkalinity agent to be provided to or mixed with water from the swimming pool or spa.

The method 700 ends at a step 710.

In some instances, after a predetermined time, the method 700 may restart at step 702. In other instances, another predetermined parameter (e.g., a measured alkalinity value or input alkalinity value) may be used to reinitiate the method 700 at the step 702.

In some instances of the methods 400-700, the first and second predetermined intervals of time may be imparted with a range of about 0.00001 seconds to about 100 hours. For example, the second predetermined interval of time and the first predetermined interval of time may be from about 0.0001 seconds to about 90 hours, or about 0.001 seconds to about 80 hours, or about 0.01 seconds to about 70 hours, or about 0.1 seconds to about 60 hours, or about 1 second to about 50 hours or about 10 seconds to about 40 hours, or about 1 minute to about 30 hours, or about 10 minutes to about 20 hours, or about 1 hour to about 10 hours. As an additional example, the second predetermined interval of time and the first predetermined interval of time may be from 0.0001 seconds to 90 hours, or 0.001 seconds to 80 hours, or 0.01 seconds to 70 hours, or 0.1 seconds to 60 hours, or 1 second to 50 hours or 10 seconds to 40 hours, or 1 minute to 30 hours, or 10 minutes to 20 hours, or 1 hour to 10 hours. In other instances, the first and second predetermined intervals of time may instead be provided as predetermined values (e.g., at least about 1 second, no more than about 1 minute, etc.). In some instances, the predetermined values for first and second predetermined intervals of time may fall within a range bounded by any minimum value and any maximum value as described above. In other instances, the first and second predetermined intervals of time may be provided as a value that falls within a range bounded by any minimum value and any maximum value as described above.

The first predetermined interval of time may be the same or different from the second predetermined interval of time. The first and second predetermined intervals of time may automatically be determined by the controller. For example, the controller may determine the first and second predetermined intervals of time based on various factors such as the size of the swimming pool or spa, a volume of water inside the swimming pool or spa, the last measured alkalinity value of the swimming pool or spa, the TDS value of the water mixed with the alkalinity agent, an amount of alkalinity agent presently within the alkalinity reagent tank, among other factors.

In some instances, the first and second predetermined intervals of time may be manually set by a user (or a technician, dealer, maintenance person, manufacturer, and the like). For example, the user may set the first and second predetermined intervals of time using the interface of the controller or by utilizing a user device that is associated with the controller.

In certain instances of the methods 400-700, the first predetermined interval of time for operating the valve in the open state may define a “first dose” of the alkalinity agent that is provided to the water of the swimming pool or spa. Similarly, the second predetermined interval of time for operating the valve in the open state may define a “second dose” of the alkalinity agent that is provided to the water of the swimming pool or spa. In some instances, the second dose of the alkalinity agent may only be provided after the first dose has been provided to the swimming pool or spa.

As a non-limiting example, if the alkalinity value is 70 ppm, the desired alkalinity value is 80 ppm, and the volume of the swimming pool or spa is 5000 gallons, the controller may determine that 340 grams (or 0.75 pounds) of the alkalinity agent should be mixed with water of the swimming pool or spa. The determined amount of the alkalinity agent may be the amount needed to maintain the alkalinity level of the swimming pool or spa within the acceptable or desirable alkalinity threshold range. Continuing with this example, the controller may then determine the first predetermined interval of time for operating the valve in the open state is 5 minutes in order to provide the first dose of the alkalinity agent to the water of the swimming pool or spa. After the first dose has been provided, the controller may determine that the second predetermined interval of time for operating the valve should be 2 minutes to provide the second dose based on the last measured TDS value (e.g., a measured TDS value obtained after the first dose was complete).

In certain instances of the methods 400-700, the controller may transmit a signal to the valve to operate in a closed state only after the concentration or total amount of the alkalinity agent provided to the water of the swimming pool or spa is substantially equal to the determined amount of alkalinity agent. In such cases, the TDS value of the water exiting the alkalinity reagent tank may be measured more than once after the valve is opened. For example, a TDS value of the water exiting the alkalinity reagent tank may be measured by the TDS sensor and provided to the controller frequently (e.g., at least once a second, at least once every 30 seconds, or at least once a minute, etc.) while the valve is in the open state. As previously described, the TDS value measured by the TDS sensor may be utilized to determine whether the concentration or total amount of alkalinity agent provided to the water is substantially equal to the determined amount of alkalinity agent. If the concentration or total amount of alkalinity agent provided to the water is substantially equal to the determined amount of alkalinity agent, the controller may transmit a signal to the valve that directs the valve to operate in a closed state. Thus, in this example, the valve is operated in the closed state after the controller receives one or more TDS values from the TDS sensor.

The present disclosure provides several technical advantages over existing approaches, including the following: automatically controlling the alkalinity level of a swimming pool or spa without any manual intervention, automatically determining an appropriate amount of alkalinity agent to be mixed with the water of a swimming pool or spa, providing a smart system including an alkalinity reagent tank for selectively releasing the alkalinity agent, and automatically controlling a valve to provide the alkalinity agent to the swimming pool or spa, thereby helping to control the alkalinity level of the pool or spa.

It will be appreciated by those skilled in the art that while the disclosure has been described above in connection with particular embodiments and examples, the disclosure is not necessarily so limited, and that numerous other embodiments, examples, uses, modifications, and departures from the embodiments, examples, and uses are intended to be encompassed by the claims attached hereto. The entire disclosure of each patent and publication cited herein is incorporated by reference as if each such patent or publication were individually incorporated by reference herein. Various features and advantages of the disclosure are set forth in the following claims.

What is claimed is:

1. A method for controlling an alkalinity level of a pool or spa, the method comprising:
providing a vessel designed to retain an alkalinity agent, the vessel being in fluid communication with the pool or spa;
measuring an alkalinity value of water of the pool or spa via a sensor at a first time period;
determining if the alkalinity value of the water is outside an alkalinity threshold range;
determining a first amount of the alkalinity agent to provide to the water of the pool or spa; and
providing the first amount of the alkalinity agent to the water of the pool or spa.

2. The method of claim 1 further comprising steps of:
transmitting a signal from a controller to a valve, wherein the signal directs the valve to operate in an open state;
providing the water of the pool or spa to the vessel, thereby forming an alkalinity agent-water mixture;
measuring a TDS value of the alkalinity agent-water mixture exiting the vessel; and
determining whether a concentration of the alkalinity agent in the alkalinity agent-water mixture substantially corresponds to the first amount.

3. The method of claim 1 further comprising steps of:
actuating a valve to an open configuration when the alkalinity value of the water is outside of the alkalinity threshold range; and
operating the valve in the open configuration for a first predetermined time period.

4. The method of claim 3 further comprising a step of closing the valve when a concentration of an alkalinity agent-water mixture leaving the vessel substantially corresponds to the first amount.

5. The method of claim 3 further comprising a step of operating the valve in a closed configuration after a first predetermined amount of time elapses.

6. The method of claim 1 further comprising a step of operating a valve in a closed state after receiving a TDS value from a TDS sensor that is within a predetermined range of acceptable TDS values.

7. The method of claim 1 further comprising steps of:
providing a valve in fluid communication with the vessel and the pool or spa;
providing a controller in electronic communication with the valve, wherein the controller is designed to receive the determined alkalinity value; and
directing the valve to operate in an open state for a predetermined period of time when a total amount of the alkalinity agent exiting the vessel is below the alkalinity threshold range.

8. The method of claim 1 further comprising steps of:
providing a controller, the controller:
receiving a value of an amount of acid dosed into the pool or spa from an acid dosing system; and
actuating a valve to allow the water of the pool or spa to be combined with a second amount of the alkalinity agent, the second amount associated with the amount of acid provided by the acid dosing system.

9. The method of claim 1 further comprising a step of determining a total amount of alkalinity agent dosed to the water exiting the vessel based on:
an average flow of the water through a flow meter in fluid communication with the vessel, and
a TDS value of the water of the pool or spa after the first amount of the alkalinity agent is provided to the pool or spa.

10. A method for controlling an alkalinity level of water associated with a pool or spa, the method comprising:
providing an alkalinity reagent tank in fluid communication with the water of the pool or spa;
determining a water chemistry parameter of the water of the pool or spa at a first time period whereby the water chemistry parameter is associated with an alkalinity value of the water; and
providing a controller in communication with the alkalinity reagent tank, the controller:
determining if the alkalinity value is above or below an alkalinity threshold range; and
determining a first amount of an alkalinity agent to provide to the water of the pool or spa.

11. The method of claim 10 further comprising steps of:
operating a valve in an open state, wherein the water of the pool or spa flows to the alkalinity reagent tank when the valve is in the open state;
receiving an indication from the alkalinity reagent tank after the first amount of the alkalinity agent is released by the alkalinity reagent tank; and
operating the valve in a closed state in response to the indication received from the alkalinity reagent tank.

12. The method of claim 10 further including a step of releasing the first amount of the alkalinity agent into the water.

13. The method of claim 10 further including a step of selectively opening and closing a receptacle of the alkalinity reagent tank to provide the alkalinity agent to the water of the pool or spa.

14. The method of claim 13 further including a step of closing the receptacle of the alkalinity reagent tank when a sensor associated with the alkalinity reagent tank determines that the first amount of the alkalinity agent has been released from the receptacle.

15. A system for controlling an alkalinity level of a pool or spa, the system comprising:
a vessel designed to retain an alkalinity agent;
a valve in fluid communication with the vessel, wherein the valve can be positioned in an open configuration and a closed configuration;
a sensor designed to determine an alkalinity value of the water of the pool or spa; and
a controller in electronic communication with the vessel and the sensor, wherein the controller is designed to:
receive the alkalinity value from the sensor at a first time period;
determine a first amount of sodium bicarbonate powder to be mixed with the water of the pool or spa; and
direct actuation of the valve into the open configuration and the closed configuration.

16. The system of claim 15 further comprising a porous strainer configured to retain the alkalinity agent.

17. The system of claim 15, wherein an alkalinity agent-water solution exits the vessel when the valve is in the open configuration.

18. The system of claim 15 further comprising a receptacle positioned within the vessel, wherein the alkalinity agent is stored in the receptacle and is selectively released by opening and closing an aperture of the receptacle.

19. The system of claim 15, wherein the controller is also designed to:
receive a TDS value from a TDS sensor positioned downstream of the vessel; and
determine if a concentration of the alkalinity agent in an alkalinity agent-water solution flowing from the vessel is substantially equal to a determined concentration of the alkalinity agent.

20. The system of claim 15, wherein the controller is also designed to:
receive an indication from the vessel after the determined first amount of alkalinity agent has been provided from the vessel; and
direct actuation of the valve to the closed configuration in response to the indication.
